(19) United States
(12) Patent Application Publication
(10) Pub. No.: US 2005/0256804 A1
(43) Pub. Date: Nov. 17, 2005

(54) Model and flow for distributing digitally conveyable content

(75) Inventors: Ciprian Agapi, Lake Worth, FL (US); Thomas E. Creamer, Boca Raton, FL (US); James R. Lewis, Delray Beach, FL (US); Vanessa V. Michelini, Boca Raton, FL (US); Wallace J. Sadowski, Boynton Beach, FL (US); Clifford J. Strohofer, Delray Beach, FL (US)

Correspondence Address: AKERMAN SENTERFITT, P. O. BOX 3188, WEST PALM BEACH, FL, 33402-3188, US

(73) Assignee: INTERNATIONAL BUSINESS MACHINES CORPORATION, ARMONK, NY (US)

(21) Appl. No.: 10/846,435

(22) Filed: May 14, 2004

(51) Int. Cl. G06F 17/60

(52) U.S. Cl. 705/52

(57) ABSTRACT

A method for distributing content can include the step of a content broker receiving digitally conveyable content from a content producer. The content broker can provide the content to at least one content distributor. The content distributor can provide the content to at least one content customer. The content producer can report content usage information to the content broker. The content broker can establish media distribution data and can convey the media distribution data to the content distributor. The content distributor can use the media distribution data and distribution data that the content broker does not have access to when providing the content to the content customer.

### BACKGROUND

1. Field of the Invention

The present invention relates to the field of content distribution and, more particularly, to a methodology for distributing digital content from a producer to a consumer in a targeted fashion.

2. Description of the Related Art

Many different distribution channels focus upon linking content producers to content consumers. Advertising can be considered one such content distribution channel, where the distributed content is an advertisement. The focus of advertising is to present information relating to a producer's product to a set of potentially interested consumers. One advertising method, called targeted marketing, attempts to define a population segment most likely to be interested in a vender's product. Advertisers have difficulty obtaining consumer information from which to perform targeted marketing.

This is true even though desired information is often available through sources having existing relationships with potential customers. For example, banking and credit card institutions, Internet service providers (ISPs), telephone companies, and the like often have access to customer profiling information. A relationship of trust between the customer and the information-possessing source, however, can prevent the information-possessing source from disseminating gathered customer-specific data. Further, portions of this customer-specific data can be protected by confidentiality agreements as well as privacy laws. It would be beneficial to advertisers if an advertisement distribution methodology existed that would permit advertisers to leverage privately-held customer-specific data without requiring the advertiser to have direct access to the customer-specific data.

Another content distribution channel can include disseminating content to interested consumers in a cost-differentiated fashion. That is, different market segments exist that are willing to pay varying amounts for content. Content producers and disseminators desire to sell content for the greatest cost that a purchasing consumer is willing to bear. Many natural market-differentiating factors can be used to determine cost.

For example, a publisher is often willing to pay more for publishing software than a student is willing to pay. Similarly, an audiophile is likely to pay a premium for an audio broadcast when compared to a jogger wearing broadcast receiving headphones. In another example, sports enthusiasts are likely to pay more for television broadcasts of sporting events involving local sports teams than for events involving geographically dispersed teams. Further, consumers with large high-definition televisions are likely to pay more for watching a movie than are consumers viewing the movie through a tiny, low-quality television. Content producers would profit from a content distribution channel that would permit variable pricing of content based upon discernable consumer-specific factors.

Yet another content distribution channel can include providing a physical medium containing digital content to a purchasing consumer. The physical medium can include, but is not limited to, such items as cassette tapes, video tapes, compact disks (CD's), digital video disks (DVDs), flash memory, paper or other stationary, photographs, and the like. The digital content can include music, video, software, mail, pictures, art, and the like. The physical medium containing the digital content is typically purchased by the consumer within a store or other such distribution outlet. Stores, however, typically provide the consumer with a limited selection of purchasable content, partially due to the expense of floor planning, shelving, and presenting a vast inventory of goods. It would be a gain for customers, distributors, and producers if distributors could allow customers to purchase physical medium containing content without requiring the distributors to have large inventories of context fixed medium occupying storefront space.

In light of the above situations, a content distribution approach is needed that allows content producers to reach a broad audience of potential customers while providing the customers with convenient mechanisms for receiving the content. Such an approach should be sensitive to customer privacy concerns, distribution costs, information overload issues, and market externalities.

### SUMMARY OF THE INVENTION

The present invention provides a method, a system, and an apparatus for distributing digitally conveyable content in accordance with an embodiment of the inventive arrangements disclosed herein. More specifically, content can be distributed in a targeted and information-centric fashion that involves interactions among entities in a content distribution chain that includes a content provider, a content broker, a content distributor, and/or a consumer. Each of the entities involved within a content distribution process can be loosely coupled with one another. Different entities can establish trusted relationships in which confidential information can be conveyed. Content can be distributed in a fashion that leverages this confidential information without exposing the confidential information to unauthorized entities within the distribution chain. Further, the medium in which content is delivered can change from one entity to the next in the content distribution chain.

One aspect of the present invention can include a method for distributing content. The method can include the step of a content broker receiving digitally conveyable content from a content producer. The content broker can provide the content to one or more content distributors. Each content distributor can provide the content to one or more content customers. The content distributor can report content usage information to the content broker. The content broker can establish media distribution data and can convey the media distribution data to the content distributor. The content distributor can use the media distribution data as well as distribution data to which the content broker does not have access when providing the content to the content customer.

Another aspect of the present invention can include one or more machine-readable storage spaces having stored thereon, at least one computer program having a plurality of code sections, said code sections executable by a machine. The computer programs can include a content broker program and a content producer program. The content broker program can receive digital content from a content producer. The content broker program can provide the digital content to the content distributor program via a telecommunication network. The content distributor program can provide the digital content to a content customer. Notably, the content broker program can establish media distribution data and can convey the media distribution data to the content distributor program. The content distributor program can use the media distribution data when providing the digital content to the content customer.

Still another aspect of the present invention can include a system for digitally distributing content. The system can include an automated content distribution system configured to establish profiles for content customers and to distribute digital content produced by an external content providing source to the content customers based upon data included within the profiles. The profiles can include private customer-specific data, which customers provide under an understanding that the private customer-specific data will not be disseminated.

It should be noted that the invention can be implemented as a program for controlling a computer to implement the functions described herein, or a program for enabling a computer to perform the process corresponding to the steps disclosed herein. This program may be provided by storing the program in a magnetic disk, an optical disk, a semiconductor memory, any other recording medium, or distributed via a network.

### BRIEF DESCRIPTION OF THE DRAWINGS

There are shown in the drawings, embodiments that are presently preferred; it being understood, however, that the invention is not limited to the precise arrangements and instrumentalities shown.

FIG. 1 is a schematic diagram illustrating a system for distributing digitally conveyable content from a producer to a consumer in accordance with an embodiment of the inventive arrangements disclosed herein.

FIG. 2 is a flow chart illustrating a method for distributing content in accordance with an embodiment of the inventive arrangements disclosed herein.

### DETAILED DESCRIPTION OF THE INVENTION

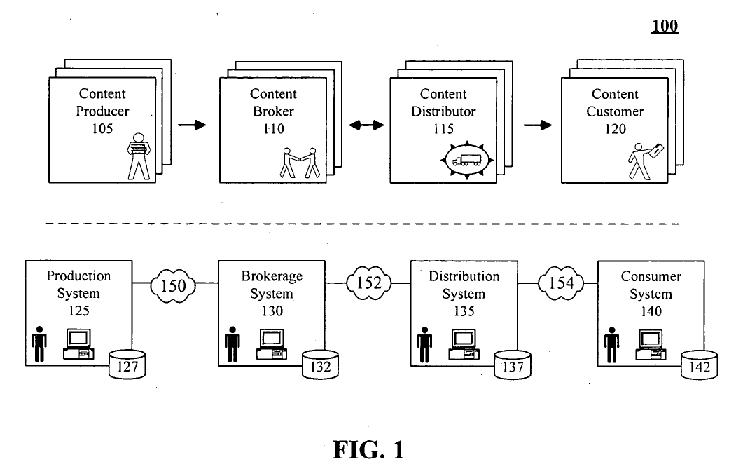

FIG. 1 is a schematic diagram illustrating a system 100 for distributing digitally conveyable content from a producer to a consumer in accordance with an embodiment of the inventive arrangements disclosed herein. Before delving into details of the system 100, a definition of digitally conveyable content is merited.

Digitally conveyable content can be content capable of being encoded as a sequence of digital numbers that have certain discrete values. Computing devices can process and convey digital content across a telecommunication network using discrete variations in voltage, frequency, amplitude, location, etc. Further, digital content can be encoded within physical medium, such as a magnetic disk, an optical disk, a semiconductor memory, and the like. After being encoded within a physical medium, such a medium can be transported from one geographical location to another. Digital content can be replicated and transmitted without suffering significant degradation and noise effects.

Examples of content commonly conveyed in a digital form can include media broadcasts, like music and video. Other content commonly conveyed digitally can include software and data. Additionally, writings, painting, photographs, and the like can be digitally encoded as content, transmitted across a network, and rendered presentable at a geographically remote location. Examples of such conveyances can include facsimiles, telegrams, voice-over-Internet-protocol (VOIP) conveyances, and the like. Communications, like advertisements, telephone calls, pages, and data packets, can be considered digitally conveyable content. Further, most forms of intellectual property can be recorded in a digitally conveyable form, thereby being digital content. The scope of the present invention covers all digitally conveyable content and the invention is not to be construed as being limited in this regard.

Referring to FIG. 1, the system 100 can include a content producer 105, a content broker 110, a content distributor 115, and a content customer 120. The content producer 105 can create content suitable for distribution. Content producers 105 can include, but are not limited to, media producers, software developers, investigators, researchers, artists, architects, advertising firms, inventors, and the like. Content producers 105 can convey their products to one or more content brokers 110 for distribution.

The content broker 110 can gather content from many different content producers 105. The content broker 110 can add value to the received content and thereafter provide the value-added content to one or more content distributors 115. The value added by the content broker 110 can be referred to as media distribution data. Media distribution data can include many elements designed for increasing the worth of the content to a marketplace. For example, media distribution data can include, but is not limited to, repackaging content in a pleasing form, combining content from multiple content producers 105 as a bundled product, digitally processing content, editing content, targeting one or more content distributors 115 for the content, targeting an audience for the content, and the like. When content is targeted for one or more content distributors 115 by the content broker 110, the content broker 110 can utilize personal contacts, content marketing skills, and the like.

Additionally, targeting an audience for the content can require market research. Market research can involve numerous forms of customer surveying, data mining, forecasting, market testing; and the like. The content brokers 110 can convey results of the market research to content distributors 115 without disclosing, the underlying research data and techniques that produced the results.

The content distributor 115 can have access to one or more content customers 120 through geographical proximity, pre-existing trusted relationships, common contacts, and the like. The data granting the content distributor 115 access to the content customer can be generically referred to as distribution data. In many situations, the distribution data available to the content distributor 115 is not available to the content broker 110. The content distributor 115 can utilize the distribution data as well as the media distribution data provided by the content broker 110 to provide content to one or more content customers 120. When content is consumed by content consumers 120, the content distributor 115 can convey usage information to the content broker 110.

In one embodiment, the content distributor 115 can maintain a profile for selective ones of the content customers 120. This profile can include purchasing habits, customer preferences, customer-specific events like birthdays, and other customer metrics. The content distributor 115 can use profile information to match available content provided by one or more content brokers 110 to potentially interested content customers 120 without disclosing the profile content to any of the content brokers 110. In a particular embodiment, profiles can include information protected under confidentiality agreements and/or privacy laws, which the content distributor 115 can nevertheless use to match available content to content customers 120.

In one embodiment, the profiles can include customer-specific data that the customers have provided to the content distributor 115 under the understanding that the provided data will not be disseminated. Further, the profile can include data available by nature of a trusted relationship between the content distributor 115 and the content customer 120. For example, content distributor 115 can be a bank having access to customer credit card records, check purchases, and the like. The content distributor 115 can be a telephone company having access to phone, records, can be an Internet service provider (ISP) knowing surfing habits, and/or can be a grocery store having access to food purchases of a customer. That is, a content distributor 115 can be any entity having special knowledge concerning one or more content customers 120.

The content customer 120 can be an end-user of the content. For example, the content customer 120 can include a software user, a book reader, a music listener, a media broadcast watcher, a magazine subscriber, a mail recipient, a data consumer, and the like. The content consumer 120 can also include an advertisement recipient and/or a solicited individual.

It should be noted that the system 100 is not limited to any particular content conveyance mechanisms. Further, the medium in which the content is delivered can change as the content is delivered from the content producer 105 to the content customer 120. In one embodiment, the content can be conveyed in a digital form via a telecommunications network between the content broker 110 and the content distributor 115. Further, the content producer 105, the content broker 110, the content distributor 115, and/or the content customer 120 can be a multitude of different entities. These entities include an automated computer system, a computerized network, a human agent, an organization, and the like.

By way of illustration, the content producer 105 can be represented by a production system 125, the content broker 110 can be represented by a brokerage system 130, the content distributor 115 can be represented by the distribution system 135, and the content customer 120 can be represented by a consumer system 140.

Each of the systems 125, 130, 135, and 140 can be an agent and/or an organization. When so implemented, the agents and/or organizations can rely upon automated computer systems to automatically perform one or more of the tasks described herein. Further, each of the systems 125, 130, 135, and 140 can be a computer system, network, and/or device.

For example, the distribution system 135 can include a consumer household media device from which a customer can request music and/or videos. The distribution system 135 can also be an automated kiosk from which a content customer can request digital content. Such a distribution system 135 can automatically record the requested content upon a physical medium, such as a compact disk, that the customer can purchase.

In another example, the brokerage system 130 can be an automated computer system configured to automatically select content distributors 115 from a repository of available content distributions based upon media distribution data. The brokerage system 130 can then automatically provide selected content distributors with access to the digital content.

In still another example, the distribution system 135 can be an automated computer system that automatically selects digital content from a repository of available content based upon customer-specific data. The distribution system 135 can automatically convey the selected content to the content customer responsive to a set of pre-programmed conditions. Further, the automated distribution system 135 can receive results of media distribution data from the automated brokerage system 130. These results can be automatically matched against profiles associated with customers.

Systems 125, 130, 135, and 140 can each have access to propriety information that can be contained in a data store, where production system 125 can be associated with data store 127, brokerage system 130 can be associated with data store 132, distribution system 135 can be associated with data store 137, and/or consumer system 140 can be associated with data store 142.

The data stores 127, 132, 137, and 142 can store information in any recording medium, such as a magnetic disk, an optical disk, a semiconductor memory, and the like. Further, each of the data stores 127, 132, 137, and 142 can utilize any information retention technique including a file-based storage technique or a database storage technique. Moreover, each of the data stores 127, 132, 137, and 142 can be a storage area fixed to a geographical location or a storage area distributed across a network space.

The production system 125 can be communicatively linked to the brokerage system 130 via distribution network 150, the brokerage system 130 can be communicatively linked to the distribution system 135 via distribution network 152, and the distribution system 135 can be communicatively linked to the consumer system 140 via distribution network 154.

The distribution networks 150, 152, and 154 can include a physical medium transportation system, like a postal service or other item delivery network, where content can be encoded within the delivered medium. The distribution networks 150, 152, and 154 can also include a telecommunication network through which content can be digitally conveyed through wireless and wireline electromagnetic signals. Each of the telecommunication networks can convey content in a packet-based or circuit-based manner. Further, each of the telecommunication networks can convey content via landlines or wireless data communication methods.

For example, each of the distribution networks 150, 152, and 154 can separately include an Intranet, an Internet, a local area network, a wide area network, or a combination thereof. In another example, each of the distribution networks can include a telephony network, like a mobile wireless network or a public switched telephone network (PSTN).

It should be appreciated that the content producer 105, the content broker 110, the content distributor 115, and/or the content customer 120 can be compensated based upon content usage. For example, the content customer 120 can receive a service or sales discount or other compensation for each advertisement that the content customer 120 experiences. In another example, the content producer 105, content broker 110, and/or the content distributor 115 can receive a royalty for each usage of content, dissemination of the content, and the like. Compensation can be dependant upon a customer usage volume, a customer usage time, a usage geographic location, content customer 120 specific-metrics, device-specific metrics for a device upon which the content is presented to the content customer 120, medium-specific metrics for a media upon which the content is presented to the content customer 120, and the like. Accordingly, the system 100 can be used to price differentiate content based upon market factors.

It should also be appreciated that the arrangements shown in FIG. 1 are for illustrative purposes only and that the invention is not limited in this regard. The functionality attributable to the various components can be combined or separated in different manners than those illustrated herein. For instance, the content broker 110 and the content distributor 115 can be implemented as a single entity within the distribution process. In such an instance, information firewalls can be used to prevent entity subsections from accessing restricted information (like customer profile information) in an unauthorized fashion.

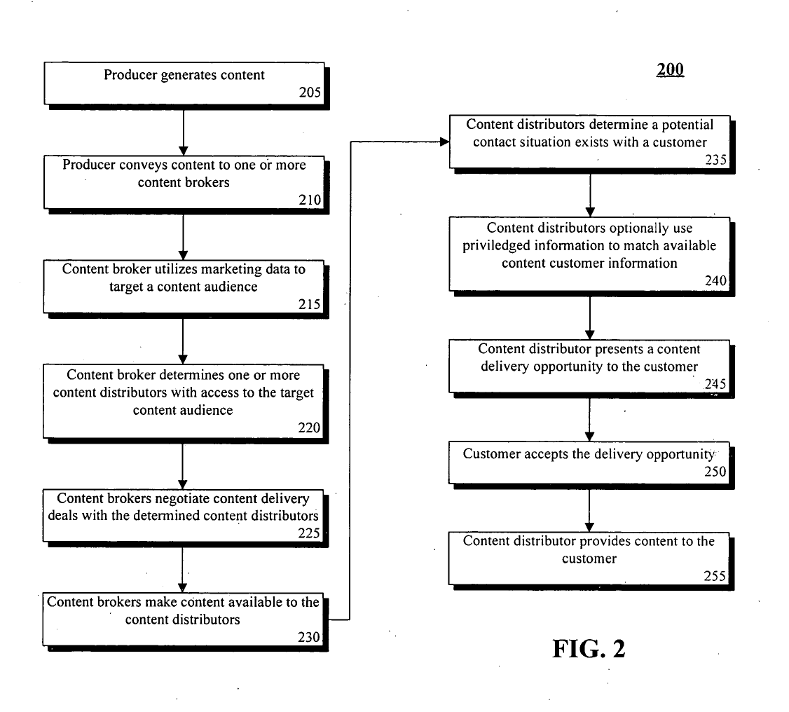

FIG. 2 is a flow chart illustrating a method 200 for distributing content in accordance with an embodiment of the inventive arrangements disclosed herein. In one embodiment, the method 200 can be performed in the context of the system 100 of FIG. 1. The method 200, however, is not limited in this regard and can be utilized in the context of any content distribution system.

The method 200 can begin in step 205, where a producer can generate content. The content can be digitally conveyable content, which can be encoded in any form. The form of encoding can change throughout the method 200 for any number of reasons like security, transportation efficiency, etc. without affecting the inventive aspects disclosed herein. Further, the content can be replicated, multiplexed, and otherwise digitally processed without negatively affecting the presented inventive aspects of the disclosed invention.

In step 210, the producer can convey the content to one or more content brokers. In step 215, each of the content brokers can utilize marketing data to target a content audience. In step 220, each content broker can determine one or more content distributors with access to the target content audience. In step 225, each content broker can negotiate content delivery deals with the determined content distributors. Different deals can be negotiated with different content distributors. In step 230, each content broker can make content available to content distributors. Making content available can involve a conveyance of medium with the content encoded, providing access to a data repository containing content, digitally conveying a copy of the content to a data repository managed by the content distributor, and the like.

In step 235, each content distributor can determine that a potential contact situation exists with a customer. For example, the content distributor can mail a bill to a customer for a provided service and an advertisement representing the content can be conveyed within the bill. In another example, the content distributor can have physical contact with the customer and a preferred customer-centric advertisement can be automatically presented by the content distributor to the customer responsive to the arrival of the customer.

In step 240, the content distributors can optionally use privileged information to match available content customers to content. That is, privileged information based upon a trusted relationship with the customers can be used by the content distributors to determine the content to which customers should be matched. In step 245, the content distributor can present a content delivery opportunity to the customer. When the content is an advertisement, the content can be automatically presented. When the content is valuable content that the customer must pay to receive, a content sample can be provided to entice the customer. Customer profiles can be compared with marketing data provided by the broker at this step.

In step 250, the customer can accept the delivery opportunity and pay any applicable fees associated with receiving the content. In step 255, the content distributor can provide the content to the customer responsive to the acceptance of step 250. The content can be delivered through a plurality of delivery channels determined by the distributor. Delivery channels can include, but are not limited to, a streaming channel, a download channel, a postal delivery channel, a storefront pickup channel, and the like.

The present invention can be realized in hardware, software, or a combination of hardware and software. The present invention can be realized in a centralized fashion in one computer system or in a distributed fashion where different elements are spread across several interconnected computer systems. Any kind of computer system or other apparatus adapted for carrying out the methods described herein is suited. A typical combination of hardware and software can be a general-purpose computer system with a computer program that, when being loaded and executed, controls the computer system such that it carries out the methods described herein.

The present invention also can be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other forms without departing from the spirit or essential attributes thereof. Accordingly, reference should be made to the following claims, rather than to the foregoing specification, as indicating the scope of the invention.

1. A method for distributing content comprising the steps of:
a content broker receiving digitally conveyable content from a content producer;
the content broker providing the content to at least one content distributor;
the content distributor providing the content to at least one content customer; and
the content distributor reporting content usage information to the content broker,
wherein the content broker establishes media distribution data and conveys the media distribution data to the content distributor, said content distributor using the media distribution data and distribution data that the content broker does not have access to when providing the content to the content customer.

2. The method of claim 1, wherein the medium in which the content is delivered changes as the content is conveyed from the content producer to the content consumer, wherein the content is conveyed in a digital form via a communications network between the content broker and the content distributor.

3. The method of claim 2, wherein a physical medium containing the content is conveyed from the content distributor to the content consumer.

4. The method of claim 3, wherein the content distributor is an automated kiosk from which the content customer requests at least one of music and video, wherein the content provided to the content customer includes the requested at least one of music and video.

5. The method of claim 1, wherein the content distributor maintains a profile for the content customer, said content distributor comparing the media distribution data against the profile when providing the digital content.

6. The method of claim 5, wherein the profile contains customer data that is not available to the content broker.

7. The method of claim 5, wherein the profile contains data protected by at least one of a confidentiality agreement between the content distributor and the customer and a privacy law.

8. The method of claim 1, further comprising the step of:
compensating at least one of the content producer, the content broker, the content distributor, and the content consumer based upon content usage.

9. The method of claim 8, wherein said compensating step is dependent upon at least one of a customer usage volume, a customer usage time, a usage geographic location, and an extent the content customer matches a target content customer as defined by the content broker.

10. The method of claim 1, wherein the content provided to the content customer includes an advertisement associated with the content producer.

11. The method of claim 10, wherein the advertisement is automatically targeted to the content customer based in part upon customer metrics stored within a computing system accessible by the content distributor, where the customer metrics are not accessible by the content broker.

12. The method of claim 1, wherein the content provided by the content producer includes a live event, wherein the live event is presented to the content customer in real-time.

13. The method of claim 1, wherein the content distributor is a household media device from which the content customer requests at least one of music and video, wherein the digital content provided to the content customer includes the requested at least one of music and video that is streamed to the content customer through a household media presentation device.

14. The method of claim 1, wherein the content broker utilizes an automated computer system to automatically select content distributors from a repository of available content distributors based upon the media distribution data, and wherein the automated computer system automatically provides the selected content distributors with access to the digital content.

15. The method of claim 1, wherein the content distributor utilizes an automated computer system to automatically select digital content from a repository of available digital content based upon customer-specific data, and wherein the automated computer system automatically conveys the selected content to the content customer responsive to a set of pre-programmed conditions.

16. At least one machine-readable storage having stored thereon, at least one computer program having a plurality of code sections, said code sections executable by a machine, said at least one computer program comprising a content broker program and a content producer program:
the content broker program receiving digital content from a content producer;
the content broker program providing the digital content to the content distributor program via a communication network; and
the content distributor program providing the digital content to a content customer, wherein the content broker program stores media distribution data used by the content distributor program, said content distributor program using the media distribution data when providing the digital content to the content customer.

17. The at least one machine-readable storage of claim 16, wherein the content distributor program maintains a profile for the content customer, said content distributor program comparing the media distribution data against the customer profile when providing the digital content, wherein the profile contains customer data that is not available to the content broker program.

18. A system for digitally distributing content comprising:
an automated content distribution system configured to establish profiles for content customers and to distribute digital content produced by an external content providing source to the content customers based upon data included within the profiles, said profiles including private customer-specific data, which customers provide under an understanding that the private customer-specific data will not be disseminated.

19. The system of claim 18, further comprising:
a repository of available digital content, wherein the content distribution system is configured to select digital content from the repository based at least in part upon data within a profile associated with a content customer, and wherein the content distribution system automatically conveys the selected content to the content customer responsive to a set of pre-programmed conditions.

20. The system of claim 18, further comprising:
an automated content brokerage system configured to provide digital content generated by a plurality of content producers to the automated content distribution system, wherein the content brokerage system is further configured to establishes media distribution data that the automated content distribution system uses to match potential content customers with available digital content, said match being based at least in part upon profile data.
